(19) United States
(12) Patent Application Publication
(10) Pub. No.: US 2025/0252344 A1
(43) Pub. Date: Aug. 7, 2025

(54) MONITORING AND ATTRIBUTION OF MACHINE LEARNING MODEL DRIFT USING A META-MODEL EXPLAINER

(71) Applicant: Adobe Inc., San Jose, CA (US)

(72) Inventors: Chiradeep Roy, San Jose, CA (US); Hsin-Ya Lou, San Jose, CA (US); Nimish Srivastav, Santa Clara, CA (US); Yuting Chen, San Jose, CA (US); Vijay Srivastava, San Jose, CA (US)

(21) Appl. No.: 18/434,302

(22) Filed: Feb. 6, 2024

(51) Int. Cl. G06N 20/00

(52) U.S. Cl. CPC G06N 20/00

(57) ABSTRACT

Techniques are disclosed for using a meta-machine learning (ML) model for monitoring and attribution of drift associated with an ML model. In an example method, a training module trains a meta-ML model to map an input feature drift to an output metric drift for an ML model. The meta-ML model is trained using meta training data including a number of meta training data points. Each data point includes an input feature drift value and an output metric drift value generated by determining, for a set of input features mapped to a corresponding set of output metrics, divergences between a set of baseline input features and the set of input features and between a set of baseline output metrics and the corresponding set of output metrics. An output module outputs a predicted output metric drift of the ML model for a particular input feature drift of the ML model.

### TECHNICAL FIELD

This disclosure generally relates to machine learning model drift and, more specifically, to techniques for monitoring and attribution of machine learning model drift using a meta-model explainer.

### BACKGROUND

Machine learning (ML) models are commonly used for generating predictions by detecting patterns in a set of input variables, sometimes called “features.” For example, in a typical use case, an ML model may be trained to make a prediction of a target variable given a set of input features. In this example, the ML model may be trained using training data that includes a number of input feature values and the corresponding values of the target variable. Various mathematical methods can be used to reduce the dependency of the trained ML model on the specific characteristics of the training data such that the ML model can accurately output predictions of the target variable.

Deployed ML models often suffer from drift. Drift refers generally to changes in the model's input data distribution or in relationships between input and output variables over time. These changes can lead to a decrease in the model's performance. Drift may include data drift, in which the distribution of input data changes over time. Drift may also include concept drift, in which the relationship between the input and output variables changes over time. Both types of drift can cause ML model performance to degrade over time, thereby making drift detection an integral part of any ML model-monitoring pipeline. Various methods exist for drift detection.

### SUMMARY

Some embodiments described herein relate to techniques for using a meta-machine learning model (meta-ML model) for monitoring and attribution of ML model drift. In an example method, a training module trains a meta-ML model to map an input feature drift of an ML model to an output metric drift of the ML model. The ML model is trained to map a set of input features to a set of output metrics. The meta-ML model is trained using meta training data generated by first receiving, by an initialization module, from the ML model, a set of baseline input features mapped to a corresponding set of baseline output metrics. The initialization module then receives, from the ML model, a number of sets of input features mapped to corresponding sets of output metrics and generates a number of meta training data points for inclusion in the meta training data. Each meta training data point includes an input feature drift value and an output metric drift value and is generated by determining, for each set of input features mapped to a corresponding set of output metrics, a first divergence between the set of baseline input features and the set of input features, which corresponds to the input feature drift value of the meta training data point. Each meta training data point also includes a second divergence between the set of baseline output metrics and the corresponding set of output metrics, the second divergence corresponding to the output metric drift value of the meta training data point. The meta-ML model then outputs a predicted output metric drift of the ML model for a particular input feature drift of the ML model.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 is a diagram of an example system implementing techniques for monitoring and attribution of machine learning model drift using a meta-model explainer, according to certain embodiments.

FIG. 2 depicts example divergence computations used for training meta-ML models for monitoring and attribution of ML model drift, according to certain embodiments.

FIG. 3 depicts an example of curation during generation of meta training data for training meta-ML models for monitoring and attribution of ML model drift, according to certain embodiments.

FIG. 4 illustrates calculated divergence metrics for several example snapshots for training meta-ML models for monitoring and attribution of ML model drift, according to certain embodiments.

FIG. 5A illustrates an example linear binning strategy used for training meta-ML models for monitoring and attribution of ML model drift, according to certain embodiments.

FIG. 5B illustrates an example linear and percentile binning strategy used for training meta-ML models for monitoring and attribution of ML model drift, according to certain embodiments.

FIG. 5C illustrates an example linear and percentile with a minimum bin used for training meta-ML models for monitoring and attribution of ML model drift, according to certain embodiments.

FIG. 6 shows a graph of an example set of output drift predictions of an example meta-ML model, according to certain embodiments.

FIG. 7A shows a graph that depicts an example of a generated meta-ML model trained using input feature values and associated input drifts, according to certain embodiments.

FIG. 7B shows a graph that illustrates an example of a generated meta-ML model trained using input feature values and associated input drifts including a baseline bias correction, according to certain embodiments.

FIG. 8 shows an example of a drift attribution report as may be generated following a determination of drift attribution, according to certain embodiments.

FIG. 9 is a flow diagram of an example process for training a meta-ML model for monitoring and attribution of ML model drift, according to certain embodiments.

FIG. 10 is a flow diagram of an example process for determining contributions to the drift attribution output by a meta-ML model for monitoring and attribution of ML model drift, according to certain embodiments.

FIG. 11 depicts an example of a computer system that may be suitable for monitoring and attribution of machine learning model drift using a meta-model explainer, according to certain embodiments.

### DETAILED DESCRIPTION

Drift detection generally involves monitoring the output of an ML model to detect drift by comparing an actual output with a predicted output. While various methods exist for drift detection, the existing methods lack adequate facilities for the accurate determination of drift attribution. Drift attribution refers to the determination of which and to what extent members of a set of input features contribute to drift in an output “scoring” metric. The output scoring metric can be an output of the ML model chosen to monitor for drift and drift attribution, such as one of the target variables.

In certain embodiments, drift attribution or an “explanation” for a particular ML model can be determined using a meta-ML model that is trained to learn a mapping between the input drift of an ML model and the corresponding predicted output drift. The predicted output drift can be used to determine the contributions to the output drift from the various input features. Existing techniques, however, can result in suboptimal mapping between the input and output drifts leading to poor predictive accuracy and explanation quality.

The techniques described herein for monitoring and attribution of ML model drift using a meta-ML model explainer include a comprehensible, scalable, and model-agnostic framework. The framework can be used to train a meta-ML model to learn a mapping from an input feature drift to an output metric drift to attribute observed output metric drift to drift of particular input features and the magnitude of the contribution therefrom. The techniques additionally include a variety of approaches for the accurate determination of drift attribution that can accommodate a wide variety of divergence metrics, binning models, baselines, and meta-ML models.

In an illustrative example, a meta-ML model is trained by a training module to map the input feature drift of an ML model to an output metric drift of the ML model. For example, consider a “customer lifetime value” (CLTV) ML model that can predict future customer revenues given input features such as customer profile information, usage data, and so on. In this example, an unexpected decrease in predicted customer revenues might be a cause for concern and could warrant mitigation if the prediction is accurate. If drift in the ML model is detected, accurate attribution of the ML model drift is needed to take mitigation action. For instance, if it is observed that predicted revenues are falling in a model that has 1,000 input features, drift attribution can be used to determine which of the 1,000 input features are the most significant contributors to the observed drift. The predicted revenue decrease may be an artifact of the offending input feature data or it may be indicative of a need to change a business strategy.

The meta-ML model for drift detection and attribution is trained using meta training data. The meta training data is generated by an initialization module by first receiving, from the ML model, a set of baseline input features mapped to a corresponding set of baseline output metrics. This baseline mapping can act a reference point for the determination of drift. The baseline mapping may be, for example, a set of input features and the corresponding set of output metrics recorded shortly after the ML model was trained or other suitable reference point. In the CLTV example, the baseline mapping may include a set of input features such as historical customer profile and usage data. The mapped set of output metrics may be actual revenue results associated with the historical input features.

As the ML model operates, the initialization module receives sets of input features mapped to corresponding sets of output metrics. For example, the ML model can be configured to periodically send sets of input features mapped to corresponding sets of output metrics to the initialization module. The initialization module then generates a number of meta training data points for inclusion in the meta training data. Each meta training data point includes an input feature drift value and an output metric drift value, each of which corresponds to a divergence between the received mapping and the baseline mapping. For instance, in the CLTV example, a divergence between a set of input features such as recent customer profile and usage data and the baseline input features may be computed. Likewise, a divergence between recent actual revenues and the historical, baseline revenues may be computed. Thus, a meta training data point includes an input drift mapped to an output drift.

The meta-ML is trained using the meta training data thus generated. Given the trained meta-ML model trained using the training dataset, the meta-ML model outputs a predicted output metric drift of the ML model for a given input feature drift of the ML model. The predicted output metric drift for the given input feature drift can then be used, by a model explainability module, to determine contributions to the predicted output metric drift from the various input features.

The model explainability module may use techniques such as the Shapley additive explanations framework to analyze the predictions of the meta-ML model and output the contributions from the various input features. In the CLTV example, the trained meta-ML model can be used to predict an output metric drift for a given recent input feature drift. The predicted output metric drift can then be analyzed using Shapley additive explanations to determine that the observed declining revenues are occurring in large part due to a factor relating to customer usage data such as customers visiting a website less often. This information can be used to mitigate the declining revenues.

The example method described above can involve a variety of features for improving the accuracy and explanatory power of the drift attribution determination. For example, the method may involve training data curation, the use of directed distance or divergence metrics, improve binning models, baseline bias corrections, quantification of differences between models, among other improvements.

The techniques disclosed herein for meta-ML model-based monitoring and attribution of machine learning model drift constitute improvements to the technical fields of ML model drift detection, attribution, and explainability. Drift is a ubiquitous problem that plagues every ML-based model monitoring pipeline. But the detection of drift is only a first step-attribution of the detected drift is necessary to determine why it is happening and what can be done about it. Therefore, the accurate drift attribution enabled using the techniques of the present disclosure improves can improve the accuracy of affected ML models when used in concert with suitable mitigation measures. Additionally, the techniques result in improved longevity of ML models because, after drift is detected, it can be more readily mitigated with accurate attribution. Along with improved accuracy and longevity comes improved confidence in the output ML models. Confidence in the ongoing accuracy of ML models is important for adoption of unsupervised models in critical applications.

The techniques disclosed herein can also improve the functioning of computers used to train and execute the meta-ML models. Because the improved meta-ML models disclosed herein determine drift attribution using only summary data measuring the divergence from a baseline, significantly smaller volumes of training data are needed to train the meta-ML model as opposed to techniques that rely on the full training dataset of the ML model. Thus, consumption of computing resources and storage can be reduced through the use of meta-ML models for drift attribution.

The techniques disclosed herein can also improve the functioning of computers used to train and execute the base ML models, whose drift is under observation. Addressing drift promptly and effectively can prevent the need for extensive retraining of the ML model. By detecting and attributing drift early, drift issues can potentially be mitigated with only incremental updates as opposed to full retraining of the ML model, which can conserve processing resources. Additionally, accurate drift attribution using the summary baseline and snapshot approach disclosed herein can reduce the consumption of computing resources through a reduction in the amount of data that must be processed to perform the attribution step. In contrast, existing techniques may require evaluation of large data sets to perform attribution. Furthermore, ML model drift may lead to degraded ML model performance which can require additional computing resources to compensate. Because the techniques disclosed herein can lead to faster drift mitigation through accurate attribution, computational resources can be conserved as the need for compensatory processing is eliminated.

### Definitions

As used herein, the term “drift” refers to changes in a ML model's performance over time. The changes can be due to data drift, in which the distribution of input data changes over time, concept drift, in which the relationship between the input and output variables changes over time, or other factors. Drift can cause model performance to degrade over time and may necessitate monitoring, retraining, or updating of the ML model.

As used herein, the term “drift attribution” refers to identification and quantification of specific factors or features contributing to the drift in an ML model's performance. This can involve, for example, analyzing how changes in the data or environment influence the model's predictions in order to target steps for adjusting or retraining the model. In the examples disclosed herein, a meta-ML model is trained to predict an output drift given an input drift. The resulting predicted output drift can be used to determine the drift attribution by explaining the output drift in terms of the input drift.

As used herein, the term “input drift” refers to changes over time in the distribution or characteristics of the input features received as input to a trained ML model. For example, in an ML model predicting revenue, a sudden shift in consumer behavior or market trends may cause input features to differ significantly from those used during training.

As used herein, the term “output drift” refers to changes over time in the behavior or performance of a ML model's outputs, independent of any input drift. Output drift may occur due to changes in the underlying relationships between input features and target variables. For example, in an ML model that predicts revenue, output drift may manifest as growing mismatch between predicted and actual revenues with no accompanying change in certain input features.

As used herein, the term “input feature” refers to independent or explanatory variables used as inputs to an ML model. Historical input features can be used train the ML model make predictions or decisions. Input features can have a value such as a scalar quantity, vector quantity, or descriptive or categorical value (e.g., red, false, or summer).

As used herein, the term “output metric,” sometimes called “target variable” or “dependent variable,” refers to an output of an ML model that the ML model is trained to predict or explain. An output metric can be used for forecasting, classifying, or quantifying concepts or entities of interest based on the input features. In the context of drift detection and attribution, the output metric refers to an ML model output used for drift detection and attribution, rather than forecasting, etc.

As used herein, the term “divergence metric” refers to a measure of difference between a set of data and a selected baseline. For example, a Wasserstein distance is a measure of the difference between two probability distributions that quantifies the minimum “cost” of transforming one distribution into the other. The Wasserstein distance is an example of a mathematical computation that can be used as a divergence metric corresponding to a given set of data and baseline.

As used herein, the term “meta-ML model” (also referred to as a meta-explainer model) is used to refer to an ML model trained to make predictions about another ML model. For example, a meta-ML model in the context of the present invention is used to map input drifts to output drifts. The predicted output drifts can be used to determine quantified drift attributions or explanations. The meta-ML model may be trained using the input features and target variables of the underlying ML model as training data.

As used herein, the term “meta training data” refers to the training data used to train a meta-ML model. In the context of the present application, for example, the meta training data is generated using the input feature values and corresponding target variable (also referred to as output metrics in this context) values of the underlying ML model. The meta training data is generated by computing divergences between datapoints and certain predetermined baselines. However, the meta training data can be or include any data relevant to the prediction of the underlying ML behaviors.

As used herein, the term “Shapley additive explainer” refers an ML tool for “explaining” the output of ML models. In one example implementation, a Shapley additive explainer can define use Shapley values, or quantifications of the contribution of each input feature to the prediction made by a ML model, considering all possible combinations of features, to attribute the contribution of each input feature to the ML model's prediction.

As used herein, the term “snapshot” refers to a collection of input feature values and their associated output metrics, as output by an ML model. The collection of input feature values can be selected to be representative of a particular time, place, or other criteria. For example, one drift analysis may use daily snapshots. Each daily snapshot may include a randomly selected input feature value sampled at roughly one-hour intervals. The daily snapshot may then have 24 input feature value and output metric pairs.

### Overview

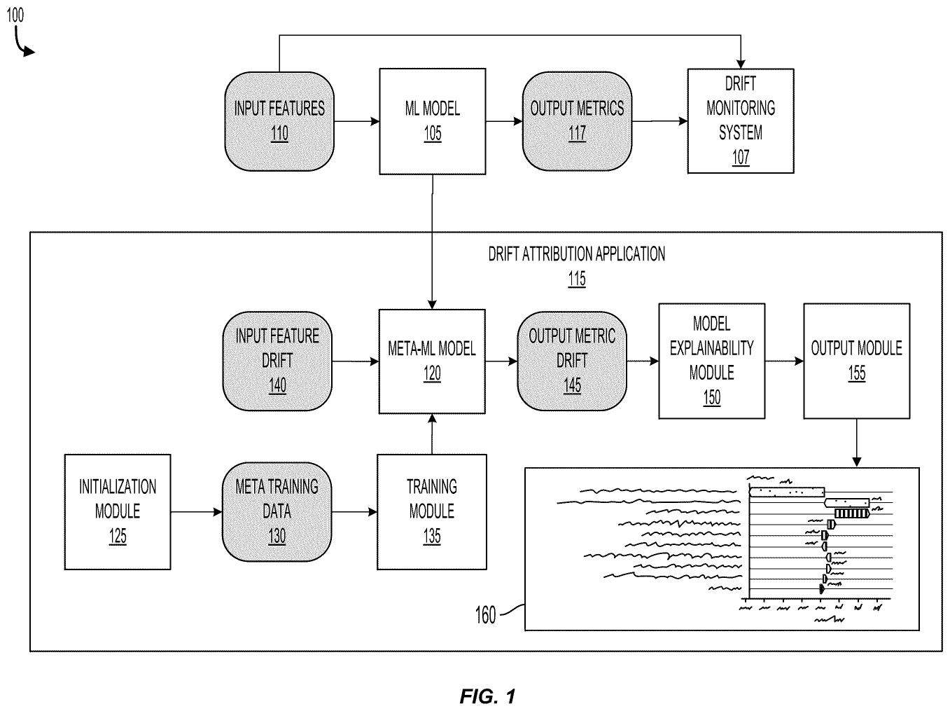

FIG. 1 is a diagram of an example system 100 implementing techniques for monitoring and attribution of machine learning model drift using a meta-model explainer. Example system 100 includes a drift attribution application 115 including components for attributing ML model drift to input features or other factors.

System 100 includes an ML model 105. In some examples, implementations of the techniques of the present disclosure are agnostic to the type of ML model 105 used. Thus, any suitable ML model 105 may be used according to different examples. In general, the ML model 105 is trained to map one or more input features 110 to one or more output metrics 117. For example, an ML model 105 may be trained to predict a future output metric such as revenues for a business given input features such as customer information, season, weather, economic data, and so on.

The ML model input or output (i.e., input features 110 or output metrics 117) may be monitored by a drift monitoring system 107 to detect input or output drift. Various methods can be used by drift monitoring system 107 to monitor ML model 105 for drift. For example, statistical tests such as the Kullback-Leibler (KL) divergence or Kolmogorov-Smirnov test (KS test) can be used to monitor input and output distributions to detect drift.

Upon detection of input or output drift by drift monitoring system 107, determination of drift attribution may be desirable in order to mitigate the drift. Drift attribution application 115 receives information from the ML model 105 including information about the input features 110 and the output metrics 117 for determining drift attribution. In drift attribution application 115, drift attribution is determined using a meta-ML model 120. The meta-ML model 120 is used to map the input feature drift 140 to the output metric drift 145. The input feature drift 140 or the output metric drift 145 may be determined by, for example, the drift monitoring system 107. In general, the meta-ML model 120 itself can be any suitable choice of ML model types, such as the types listed above with respect to the ML model 105. However, the quality of the resultant drift attributions may vary among meta-ML model types. Notably, the type of ML model 105 and the type of meta-ML model 120 can be different or the same.

The meta-ML model 120 is trained by a training module 135. The training module 135 includes components for training the meta-ML model 120 to map the input feature drift 140 to the output metric drift 145 using meta training data 130. The meta training data 130 is generated by an initialization module 125.

In some examples, the initialization module 125 generates the meta training data 130 by computing “divergences” between input features 110 and output metrics 117 and predetermined baseline input features and output metrics. The divergence may be a measure of change or difference between the input features 110 and output metrics 117 and the predetermined baseline. This can effectively transform a mapping from the input features 110 to the output metrics 117 into a different mapping from the space of drift in the underlying input features 110 to the drift in the output metrics 117. The meta training data 130 includes one or more meta training data points, each of which includes divergences of one set of input features and their associated output metrics from the baseline.

The trained meta-ML model 120 can be used to predict an output metric drift for a given input feature drift. The output metric drift can be used by a model explainability module 150 to determine a set of attributions, sometimes referred to as contribution measures, for a particular output metric drift. The contribution measures can be used with an explainability framework such as a Shapley additive explainer to compute attributions for the given output metric drift. The explainability framework may receive, for example, an input feature drift and an associated output metric drift. Additionally, the explainability framework may receive a background dataset, which may include all or a subset of the meta training data.

For example, consider a predicted output metric drift relating to a revenue prediction with a magnitude of −$1,000. In one example output, the output metric drift may be broken down according to attributions such as −$500 due to a change in customer preferences, −$750 due to a seasonal influence, and +$250 due to an economic factor.

The contribution measures determined by the model explainability module 150 may be used by the output module 155 to output the drift attributions using a suitable format such as a graphical, tabular, or report-based format. For example, the output module 155 can generate visualization 160 for a readily comprehensible representation of the computed attributions. For instance, the output of a Shapley explainer can be used to generate waterfall plots as shown in visualization 160 that break down the output metric drift as the weighted sum of input feature drifts.

In some examples, the output module 155 can generate notifications, warnings, emails, alarms, alerts, etc. when drift attributions are detected in an online (e.g., continuously or autonomously executing) drift attribution application 115 to notify administrators so that mitigation action can be promptly taken. For instance, an online drift attribution application 115 may send a warning or push notification to administrators when a drift attribution is detected with a magnitude that exceeds a predetermined threshold.

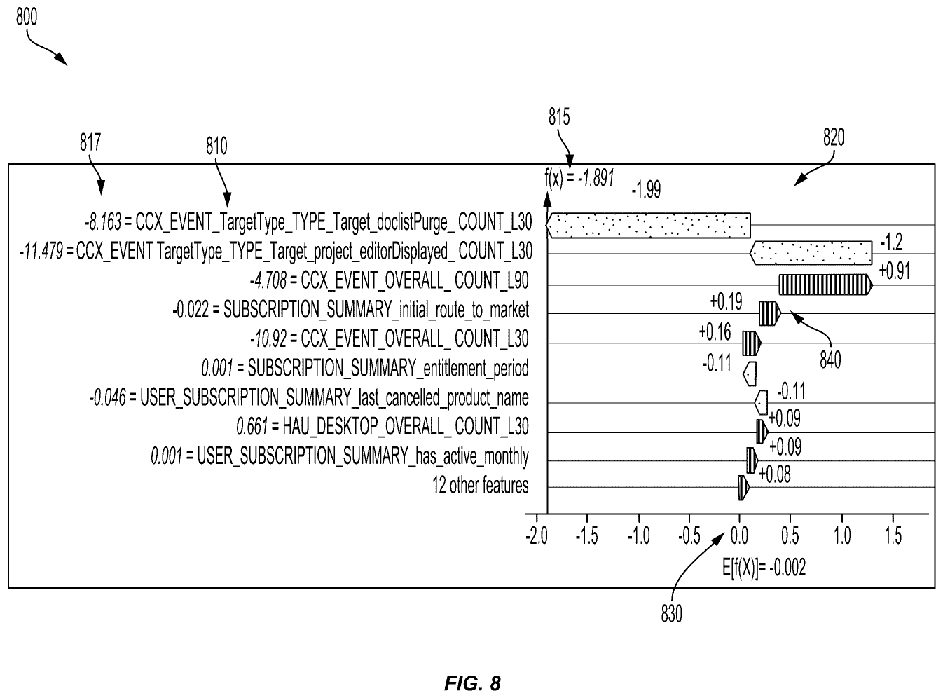

For example, the output module 155 can generate a notification when the determined contribution measures exceed a predetermined threshold. The generated notification can include information about the predicted output metric drift of the ML model 105 for the particular input feature drift of the ML model 105. For instance, the notification may include the magnitude of the predicted output metric drift as well as a breakdown of the drift attribution, with significant contributions to the drift highlighted to draw attention for specific mitigations. The information about the predicted output metric drift of the ML model 105 can likewise be used for generating a report or visualization such as the example shown in FIG. 8.

### Initialization

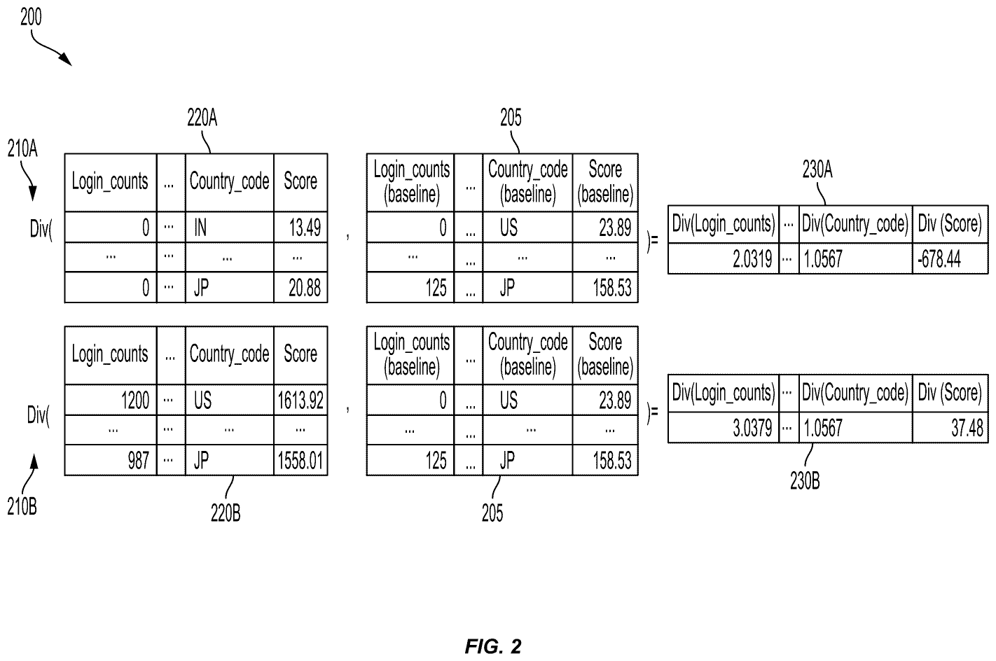

FIG. 2 depicts example divergence computations 200 as may be performed by the initialization module 125 for generation of the meta training data 130. More formally, for an ML model 105 that maps a set of input features x={x₁, . . . , xₖ} (e.g., input features 110) from the feature space to a output scoring metric y (e.g., one of output metrics 117), the training module 135 trains meta-ML model 120 to learn a mapping from the input feature drift space [drift(x₁), . . . , drift(xₖ)] (e.g., input feature drift 140) to the output drift drift(y) (e.g., output metric drift 145). In certain embodiments, the divergence computations 200 are used to convert the input features 110 and output metrics 117 to feature space.

A divergence can include one or more divergence scores that relate one input feature value to another input feature value. Likewise, a divergence for output metrics can include one or more divergence scores that relate the corresponding output metric value to another output metric value, corresponding to the other input feature value. In the examples shown in FIG. 2, the input features 110 include “Login_counts” which may correspond to the number of times an aggregate number of users from a particular locale have logged into an e-commerce website and a “Country_code,” representing the locale of the login counts. The associated output metrics are labeled as “Score.” The score may be, for example, revenues or a measure related to revenues for the e-commerce website for each aggregate group of users in each locale. For instance, input features 220A include two sets of input features, including login counts in both India and Japan. The output metrics may be actual revenue amounts or some other measure that is proportional to or otherwise a function of revenues. FIG. 2 also illustrates that the input features 110 may be categorical or numerical. Categorical features represent discrete, typically non-numeric data, like country codes or types. Numerical features are quantitative and represent data in numeric form, like login counts, revenues, or dates.

The meta training data 130 can be generated by first selecting a set of baseline input features mapped to a corresponding set of baseline output metrics, sometimes referred to as a baseline scoring snapshot or just “baseline.” The baseline 205 can serve as a point of reference against which drift for subsequent sets of input features and output metrics will be calculated. Various sets of input features and output metrics can be chosen for the baseline 205. For example, the baseline 205 might include the set of input features and output metrics recorded shortly following the training of the ML model 105. Another example may be a set of input features and output metrics that are designated as “ideal” by a developer or user of the ML model 105. For instance, the ideal output metric may be determined using best-case assumptions or aggregate historical data. The baseline 205 can be used for subsequent divergence calculations for generation of meta training data points. Each divergence computation is thus converted to a single meta training data point that captures the input and output drift with respect to a baseline 205.

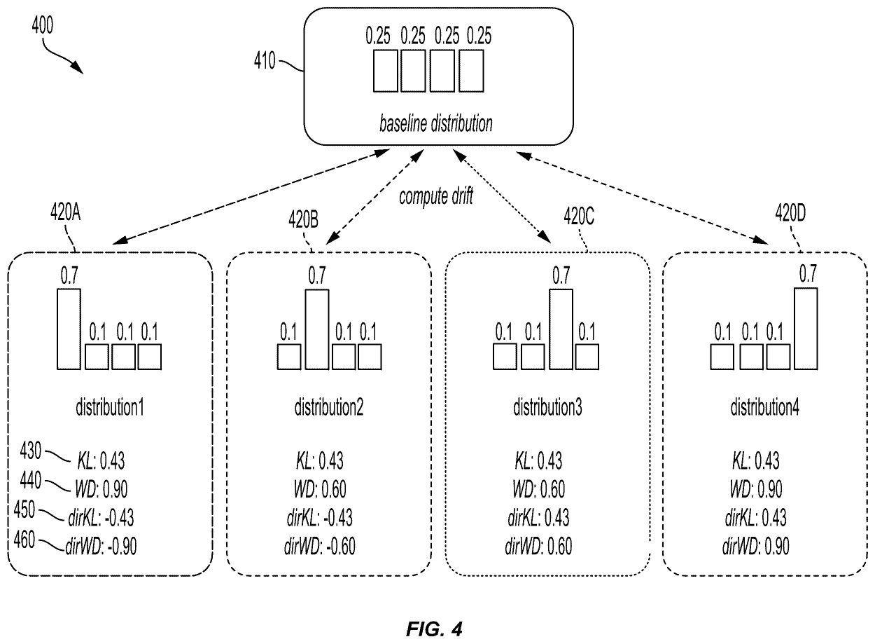

In the first example 210A, divergences 230A are computed from input features and output metrics 220A and baseline 205. Divergence can be computed using various methods including the Kullback-Leibler (KL) divergence and the Wasserstein distance, as will be described in more detail with respect to FIG. 4 below. Divergences 230A includes a set of first divergences corresponding to the divergence between the input features of 230A and the input features of the baseline 205. Divergences 230A likewise includes a set of second divergences corresponding to the divergence between the output metrics of 230A and the output metrics of the baseline 205.

For example, the divergence 230A for the “Country_code” input feature can be determined by first generating a histogram or other suitable summary data structure representing a count of the various country codes found in input features and output metrics 220A. Similarly, a second histogram can be generated that represents the count of the various country codes found in baseline 205. The divergence of the “Country_code” input feature can then be determined using the KL-Divergence, Wasserstein distance, or other suitable measure to convert the determined divergence between the two generated histograms into a divergence score. The divergence scores determined for some or all of the input features can be combined into a divergence value that characterizes the input features and output metrics 220A.

In this example, the divergences were determined using a particular method, but another method may result in different values. Similarly, in the second example 210B, divergences 230B are computed from input features and output metrics 220B and baseline 205. Importantly, the same baseline 205 is used for all divergence computations for a particular drift attribution determination. The divergences 230A, 230B are examples of meta data training data points that make up the meta training data 130.

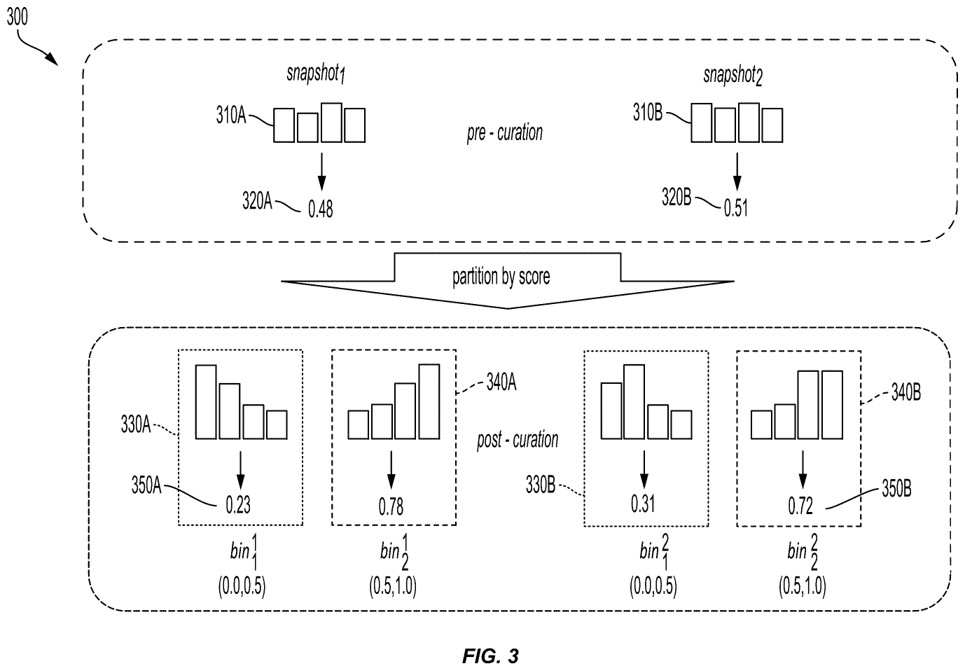

FIG. 3 depicts an example of curation 300 during generation of the meta training data 130. In some cases, there may be insufficient examples to capture some interactions between the changes in input features 110 and the corresponding changes in the output metrics 117 required for an accurate computation of drift. For example, a correlation between a trend in an input feature distribution and the associated output metrics may not be captured without curation 300 during generation of the meta training data 130. Curation 300 can also increase the number of meta training data points by a factor proportional to the number of portions of each snapshot, which can mitigate inaccuracies due to sparse data.

In some examples, curation 300 during generation of the meta training data 130 may be performed by the initialization module 125. In one example approach to curation of the meta training data, curation 300 can occur while generating meta training data points for inclusion in the meta training data 130. For each snapshot (or a subset thereof) obtained prior to calculation of drift with respect to the baseline 205 (e.g., a divergence calculation), the initialization module 125 can determine at least 2 portions of a snapshot based on the corresponding set of output metrics. In some examples, the at least 2 portions of each set of input features can be determined based on an equal-width partition of an output metric range of at least one output metric of the set of output metrics. For instance, if the output range varies over [0, 1.0], the portions may be determined by partitioning this output metric range. The example below uses 2 portions, but any suitable number of portions can be used to capture the features of the input and output distributions for accurate drift determination and attribution. Curation using this example approach can effectively double the number of meta training data points, mitigating suboptimal meta-ML model 120 training due to sparse training data.

For example, a snapshot may be represented as a histogram. The histogram may include bins that are configured with lower and upper limits corresponding to the distribution of input feature values. For instance, a simple example involving a single input feature and an output metric is depicted in curation 300. Snapshots 310A and 310B prior to curation 300 show histograms with 4 equal-sized bins over a range corresponding to the range of the input features. The histogram bar values represent counts of input features values in the range defined by the bin values for a particular snapshot.

For instance, snapshot 310A may be a histogram based on a total of 24 input feature values corresponding to a daily snapshot based on hourly samples of an ML model 105 output. The leftmost bin of snapshot 310A may be defined by the range [0, 10] and have a magnitude proportional to the size of the leftmost bar of snapshot 310A shown. Similarly, the remaining bins may have count magnitudes proportional to the size of the remainer of the bars shown in snapshot 310A.

The input features 110 can have associated output metrics 117. The average values 320A, 320B of the of the output metrics 117 are also shown. In some examples, the output metrics 117 can be normalized. In the example shown, the output metrics 117 are normalized to the range [0, 1.0]. For instance, the normalized range of the output metrics 117 may correspond to minimum and maximum values of the output metrics 117, but other normalization schemes can be used.

The selection of the partitions of the snapshots 310A, 310B can be based on the output metrics 117. For example, given output metrics 117 normalized to [0, 1.0], the snapshots 310A, 310B can be partitioned such that a first partition includes input feature and output metric pairs with an output metric value of [0.0, 0.5) and a second partition corresponding to output metric values of [0.5, 1.0].

The sub-snapshots following the partition in this simple example are shown. The snapshot 310A is partitioned into sub-snapshots 330A and 340A. The snapshot 310B is partitioned into sub-snapshots 330B and 340B. As a result of the partition, the average values 350A, 350B for the sub-snapshots are shown, with values reflecting the selection of the 2 partitions (only 2 of 4 averages are labeled for clarity). Notably, following the partition, sub-snapshots 330A, 340A now capture a symmetric trend about the selected partition threshold. Sub-snapshots 330B, 340B likewise capture an asymmetric but clearly visible trend.

Following partition, the initialization module 125 can then determine a weight value for each of the 2 portions of the snapshot. The weight value can be based, for example, on a measure of a size of each respective portion of the snapshot. For example, suppose snapshot 310A contains input feature values and is partitioned into sub-snapshots 330A and 340A based on an output metric threshold of 0.5. The result may be 30 input feature values and output metric pairs in sub-snapshot 330A and 70 in sub-snapshot 340A. In that case, weights of 3 and 7, respectively, may be determined. The weight values may be appropriately scaled as necessary for the particular application. For example, in some examples, the weight values may be normalized to 1.0.

Computation of meta training data points can proceed as described with respect to FIG. 2. A first and second divergence can be determined to represent input feature drift value and output metric drift value for each of the portions of the snapshots. The curated meta training data points thus computed can be weighted using the determined weights when training the meta ML model 120. Weighing the curated meta training data point by a factor proportional to the size of each portion can ensure that outlier scores are not over-represented during the training of the ML model 120.

The example of FIG. 3 illustrates a particular method for curation 300 of the meta training data 130. However, the techniques described above can be applied for other approaches to curation 300 of the meta training data 130. For example, meta training data 130 could be curated by combining snapshots, shifting snapshot windows, variable-width binning, and so on.

### Drift Determination

As described above, a divergence metric can be used to calculate the input drift and the output drift with respect to a predetermined baseline. For example, a divergence metric may be determined by comparing a given snapshot with a predetermined baseline snapshot and performing a mathematical operation. However, as the divergence metric can be determined using various methods, care must be taken to ensure that drift detection and attribution is not unduly influenced by the choice of method for calculating the divergence metric.

FIG. 4 illustrates divergence calculation 400 showing calculated divergence metrics for 4 different snapshots 420A-420D from baseline snapshot 410. Each snapshot 420A-420D is illustrated with 4 different methods for determining the divergence metric. Each method is labeled only once for clarity (430, 440, 450, and 460) and will be described in more detail below. The snapshots 420A-420D are unimodal distributions, each with a prominent peak or mode in a single bin in contrast with all other bins for illustrative purposes.

For example, one method for calculating the divergence method is the Kullback-Leibler (KL) divergence 430. As the KL divergence 430 is based on pairwise comparisons for each bin, it may not capture differences between distributions with particular characteristics. Additionally, as a measure of distance, the KL divergence 430 lacks directionality and can fail to capture asymmetric relationships between the snapshots 420A-420D and the baseline 410. For example, the KL divergence 430 is shown in divergence calculation 400 for each snapshot 420A-420D. While the unimodal snapshots 420A-420D vary significantly, the KL divergence 430 with baseline snapshot 410 is identical in each case.

In another example, the Wasserstein distance 440, also known as the “Earth Mover's Distance,” can be used to determine the divergence metric. The Wasserstein distance, and similar approaches to differentiating distributions, can include a number of combined divergence scores relating a first group of input feature values to a second, respective group of input feature values. For instance, the Wasserstein distance may represent the total amount of work (e.g., the number of discrete operations) required to transform one distribution into another. Both the first and second divergences can be determined using the Wasserstein distance.

For example, the Wasserstein distance 440 is shown in divergence calculation 400 for each snapshot 420A-420D. The Wasserstein distance 440 can capture some differences between snapshots 420A-420D and baseline snapshot 410. However, the Wasserstein distance 440 is also an undirected metric and may not be able to capture the difference between symmetric distributions. This can be seen, for example, in divergence calculation 400 where the mirror-image snapshots 420A and 420D yield the same Wasserstein distance 440. In some cases where the direction of the drift in the input feature distributions and the output metric distributions are strongly correlated, symmetric distributions can lead to identical Wasserstein distance determinations and mask the underlying directionality of the drift.

In another example, directed metrics can be used to capture both the distance and direction of drift. Using one example technique, the direction of shift can be determined by determining the median of the snapshot 420A-420D and assigning a sign (positive or negative) based on the position of the median relative to the baseline. For example, if the median of the snapshot 420A-420D is less than the median of the baseline 410, a negative sign can be applied to the divergence metric. Likewise, if the median of the snapshot 420A-420D if greater than the median of the baseline 410, a positive sign can be applied to the divergence metric. However, other approaches to the determination of direction can be used as well.

The determination of direction can be used in concert with other means for determining the divergence metric. For example, the determination of direction can be used in addition to the KL divergence 430 or the Wasserstein distance 440. The directed KL divergence 450 is shown in divergence calculation 400. The directed KL divergence 450 captures the symmetry in the snapshots 420A-420D but still fails to capture the asymmetry in the underlying distributions. The directed Wasserstein distance 460 captures both the symmetry in the snapshots 420A-420D and the shape of the underlying distributions, yielding a unique value for each divergence metric calculation for snapshots 420A-420D. In some examples, the directed Wasserstein distance 460 may yield the most accurate results for drift attribution determination. In addition, the use of the directed metrics may lend themselves to more effective interpretability since the direction of drift from the baseline can be more readily visualized.

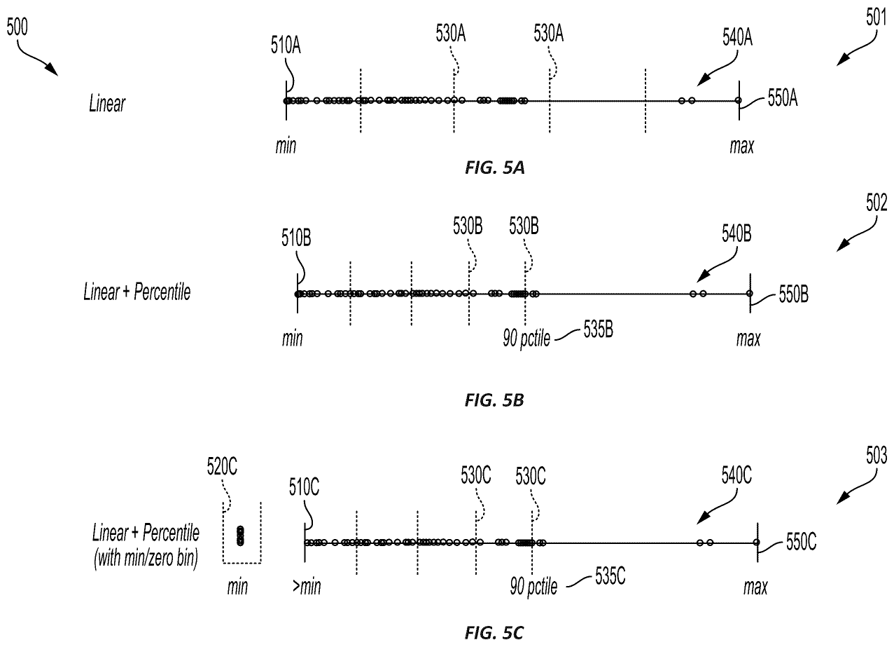

Turning next to FIGS. 5A-5C, FIGS. 5A-5C illustrate several example binning strategies 500. Binning strategies 500 may be applied to snapshots prior to computation of the divergence metric. The accuracy of drift attribution can be related to the quality of the input feature and output metric distributions input to the selected divergence metric. The quality of the input feature and output metric distributions may depend on the choice of binning strategy.

The selected binning strategy may include variations on snapshot attributes such as granularity or binning model. Granularity can include the number of bins. For example, increasing the number of bins may increase the sensitivity of the meta ML model 120. However, a large number of bins can result in undesirable sensitivity to slight changes in the input feature and output metric distributions. Binning model refers to the methodology being used to compute, for example, bin widths or bin boundaries.

A first example binning strategy is a linear binning strategy 501. A linear binning strategy 501 can be applied to a distribution with minimum value 510A and maximum value 550A. The minimum value 510A and maximum value 550A can be used to compute the range of the distribution. The computed range can be divided into a predetermined number of bins 530A of equal width, with respect to, for example, the output metric value associated with each input feature value in a particular set of input features and associated output metrics. Selection of the linear binning strategy 501 can be sensitive to outliers 540A.

A second example binning strategy is a linear and percentile binning strategy 502. A linear and percentile binning strategy 502 can be applied to a distribution with minimum value 510B and maximum value 550B. The minimum value 510B and maximum value 550B can be used to compute the range of the distribution. In one example implementation, the portion of the range 535B containing a cutoff of 90% by value of the distribution can be determined (e.g., the 90th percentile). This portion of the range 535B can then be divided into a predetermined number of bins 530B of equal width, similar to the linear binning strategy 501 described above. The remaining portion (the remaining 10% of the input values in this example) can be the final bin. In this example, a significant number of outliers 540B may be allocated to the last bin.

Other percentage-based allocations of the range may also be used. For example, in cases where the lower-valued end of the range is unbounded, a range containing values between cutoff values including the lower 10% of values and the upper 90% of values can be divided using the linear binning strategy 501. The remaining two bins can then include all values less than the lower 10% bound and the upper 90% bound, both by value.

A third example binning strategy is a linear and percentile with a minimum bin binning strategy 503 that defines a boundary portion of the range 535C. The linear and percentile with a minimum bin binning strategy 503 can be applied similar to the linear and percentile binning strategy 502 with the addition of a minimum or zero-value bin 520C. For example, an input feature with a large number of zero values can erroneously result in an undetected output drift. The minimum or zero-value bin 520C can hold input feature values whose values are exactly equal to zero or less than a predetermined minimum value. As above, the linear and percentile with a minimum bin binning strategy 503 can be applied to a distribution with minimum value 510C and maximum value 550C. The minimum value 510C and maximum value 550C can be used to compute the range of the distribution. A portion of the range 535C can be used to determine bins 530C using the linear and percentile binning strategy 502, resulting in significant number of outliers 540C allocated to the last bin or bins.

Several example binning strategies 500 are described above. However, the examples described should not be construed to limit the types of binning strategies 500 that may be used. For instance, other possible binning strategies may include percentile based bins, percentile based bins with edge bins on one or more extremes of the input feature distributions, and so on.

In general, factors to be considered for selection of a binning strategy may include, for example, determination if an input feature is distributed uniformly. In that case an equal width binning strategy may result in sufficiently accurate drift attribution. In another example, if an input feature is distributed non-uniformly or with unknown bounds, then a percentile-based binning model may be preferred over the equal width binning model. The selection of binning model may be chosen to capture the underlying features of the input feature and output metric distributions balanced against the potential loss of details due to the summarization inherent in the binning process.

### Model Explanation and Attribution

In addition to the refinements to predictive accuracy of the meta-ML model 120 described above, the explanation quality of the meta-ML model 120 refers to how effective the meta-ML model 120 attributes the output drift to the input drift with respect to the baseline distribution. In some examples, a model explainability module 150 can be used to determine contribution measures for the one or more input features corresponding to the first divergences of the plurality of generated meta training data 130. The contribution measures can be based, for example, the predicted output metric drift of the ML model 105 for the particular input feature drift of the ML model 105.

For example, once the meta-ML model 120 is trained, the predicted output drifts 610 can be input to a Shapley tree explainer to resolve the predicted output drift 610 into a summation of Shapley values for each of the input features. The Shapley Tree Explainer includes methods based on the Shapley additive explanations framework for explaining predictions made by ML models. A Shapley value can refer to a quantification of the contribution of each input feature to a prediction made by the ML model.

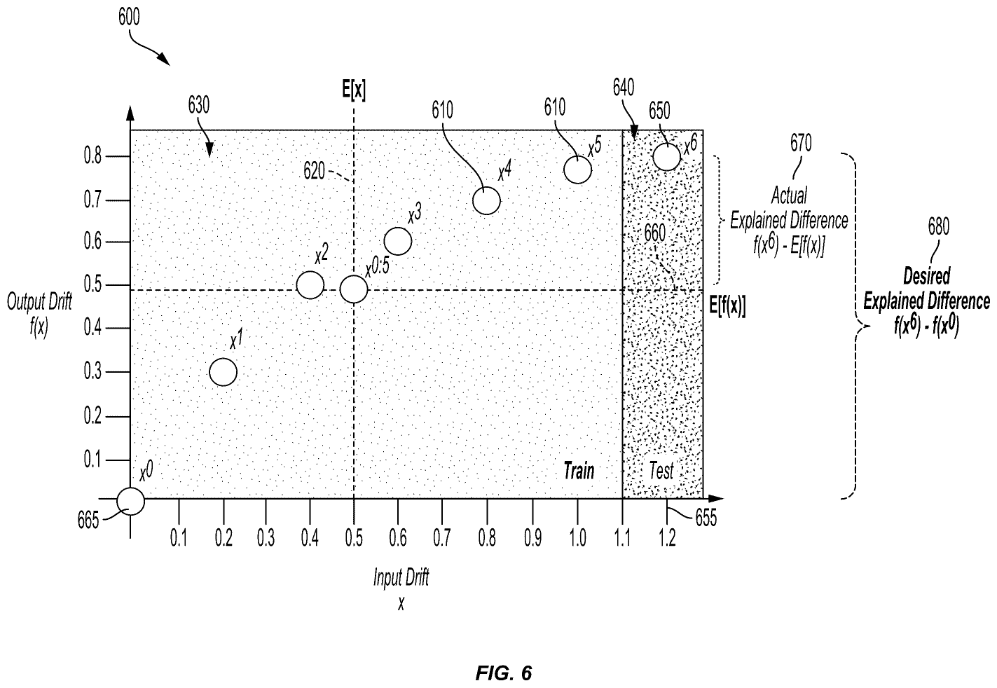

FIG. 6 shows a graph 600 of an example set of output drift predictions 610 of an example meta-ML model 120. Graph 600 includes the plotted meta training data 630 and plotted meta test data 640. The plotted meta test data 640 may be, for example, a possible test output drift 650 for a given test input drift 655. Alternatively, the plotted meta test data 640 may be a portion of the meta training data 130 reserved for model evaluation after training.

FIG. 6 also depicts the quantities explained using the model explainability module 150 such as a Shapley tree explainer. For example, the model explainability module 150 can explain the explained difference 670, representing a difference between possible test output drift 650 and expected output drift 660, denoted E[f(x)]. Expected output drift 660 is the expected output drift for the expected input drift 620, written as E[x].

The expected drifts 620, 660 constitute a “background dataset” that can be used as a reference against which to compute the Shapley values by the Shapley tree explainer. The background data set represents the average or baseline scenario against which the contributions of individual input features in a specific prediction are compared. Thus, application of the Shapley explainer to the meta-ML model 120 output can generate Shapley values that are generated dependent on the expected output drift 660.

This may occur because all or a significant portion of the meta training data 130 used to train the meta-ML model 120 is input to the Shapley explainer as part of the background data set. However, using all or a significant portion of the meta training data 130 to compute the expected output drift 660 can lack the desired explanatory power in some cases. For instance, it may be desirable to compare the predicted test output drift 650 for test input drift 655 against the baseline input and output drift 665 and not all or a significant portion of the meta training data 130.

For example, a given input drift and predicted output drift for the meta-ML model 120, the predicted Shapley values may add up to f(xⁱ)−E[f(x)] where f(xⁱ) is the predicted output drift for input drift point xⁱ and E[f(x)] is the expected output drift 660, as described above. For instance, for the predicted test output drift 650 for test input drift 655, the Shapley values may provide drift attribution for the explained difference 670 given by f(x₆)−E[f(x)], representing a divergence or drift from all or a significant portion of the meta training data 130.

Computing drift attribution for the explained difference 680, denoted by f(x₆)−f(x⁰), may instead be desirable since using all or a significant portion of the meta training data 130, the model explainability module 150 (e.g., the Shapley explainer) effectively compares the predicted test output drift 650 point to a synthetic output drift point defined by the coordinates of the expected input drift 620 and the expected output drift 660, representing aggregated information from all or a significant portion of the meta training data 130. The result may be a low-quality explanation that is difficult to interpret.

To compute the drift attribution for the explained difference 680, or f(x₆)−f(x⁰), the model explainability module 150 can generate the contribution measures (e.g., the Shapley values) for the test input drift 655 (or input drifts) used a background dataset based on a predetermined set of input features corresponding to a predetermined set of input feature drift variables, such as the baseline 665 described above with respect to FIG. 2.

For example, the Shapley explainer may be provided as a background dataset only with the baseline input and output drift 665. This choice of background dataset ensures that the Shapley explainer uses, as its expected output drift 620, E[f(x)]=f(x⁰). As a result, the Shapley explainer can directly compare each test input drift 655 (or input drifts) against the baseline point x⁰. The resulting drift attribution can result in a more intuitive and comprehensible explanation since the predicted test output drift 650 represented how much the predicted test output drift 650 has drifted from the baseline output drift 665. In addition, using all or a significant portion of the meta training data 130 as the background dataset can result in a gap between the expected output drift 620 and the baseline output drift 665 which can be similarly difficult to interpret.

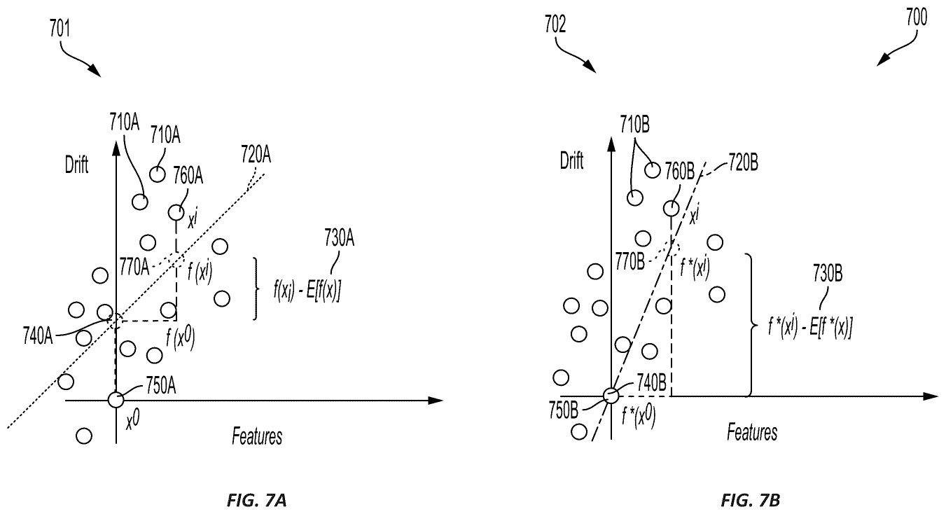

Turning next to FIGS. 7A-7B, FIGS. 7A-7B show graphs 700 illustrating the effect of baseline input and output drift values on the interpretability of predicted output drifts or drift attributions. In some examples, the baseline output drift 740A denoted by f(x⁰) for the baseline input drift x⁰ 750A may be a non-zero value which can lead to drift attributions that are non-intuitive and do not accurately represent how far a given input feature x′ has deviated from the baseline input feature value x⁰ 750A.

FIG. 7A includes graph 701 that depicts an example of a generated meta-ML model 720A trained using input feature values and associated input drifts 710A. The model 720A is represented by a line that relates input feature values to predicted output drift values. In graph 701, an example output drift prediction 770A, given by f(x), is shown for a particular input feature value 760A, denoted by xⁱ. The deviation 730A of the particular input feature value 760A x¹ from the baseline output drift 740A fails to capture the deviation from the baseline output drift 740A since the baseline output drift 740A is non-zero.

The meta-ML model 720A can be regularized for zero-bias for improved interpretability. The zero-bias correction can, for example, ensure that for a baseline input drift with value zero corresponds to a predicted baseline output drift of zero. In one example, regularization for zero-bias can be performed by first defining a hyperparameter w⁰ such that:

$$L ( x , y ) = {w}^{0} \cdot L ( 0 , f ( {x}^{0} ) ) + {\sum }_{i} {w}^{i} \cdot L ( {y}^{i} , f ( {x}^{i} ) )$$

in which L(x, y) is the weighted loss function for a set of m+1 meta training data points having the form {(x⁰, y⁰), (x¹, y¹), . . . , (x^{m}, y^{m})} where xⁱ and yⁱ are the ith set of input drifts and output metric drift, respectively. The weights we can be obtained using a procedure similar to the determination of the weights during the curation 300 process described above with respect to FIG. 3. The baseline weight w⁰ can be set to any suitable value that accords with the desired explanatory power. In one example, the baseline weight w⁰ is set to k·Σᵢwⁱ, in which k is a scaling factor.

The meta-ML model 120 can be trained or re-trained using this weighted loss function. Use of the weighted loss function given above can ensure that the predictions of the meta-ML model 120 for the baseline input feature value x⁰ approach zero. Moreover, use of this weighted loss function during training of the meta-ML model 120 can cause the relative deviation of the predicted output drift f(xⁱ) of the test point xⁱ to be accurately reflected.

FIG. 7B includes graph 702 that illustrates an example of meta-ML model 720B trained using input feature values and associated output drifts 710B. The meta-ML model 720B has been trained using the weighted loss function above, which effectively zeroes the bias of the baseline output drift 740B, f(x⁰), corresponding to baseline input drift 750B, x⁰. In graph 702, an example output drift prediction 770B, given by f(xⁱ), is shown for a particular input feature value 760B, denoted again by x′. The deviation 730B of the particular input feature value 760B xⁱ from the baseline output drift 740B now captures the deviation 730B from the baseline output drift 740B given the bias-corrected baseline input drift 740B.

### Model Identification

As discussed above, output metric drift can, in some cases, be attributed to different kinds of input drift. For example, input drift can include drift in input features, sometimes referred to as data drift. In another example, input drift can include changes in the underlying model or concept, sometimes referred to as concept drift. In this context, “concept” refers to the relationship between the input features and the output metric(s). Concept drift can be measured by introducing additional input features that can be used to distinguish one model or concept from another.

In some examples, concept drift can be measured by the model explainability module 150 by first determining a set of top input features based on the contribution measures for the one or more input features. For example, if the model explainability module 150 is using a Shapley explainer, the contributions may be a predetermined number of top Shapley values. Likewise, a set of baseline input features corresponding the top Shapely values can be determined. For example, if two top Shapely values are selected based on the two largest input feature contributors to the output drift, then the baseline input features can include the Shapely values corresponding to the two input features as determined from the baseline snapshot.

The model explainability module 150 can generate a vector representation of the set of top input features and a vector representation of the set of baseline input features. Vector representations can be generated by, for example, computing the average Shapley value for each feature in the associated meta training data. These vector representations should both have the same predetermined number of elements, corresponding to the number of top Shapley values selected and the number of features in the set of baseline input features. The model explainability module 150 can then compute a dot product of the vector representation of the set of top input features and the vector representation of the set of baseline input features. The dot products of the vector representations can be used to quantify concept or model drift. The computed dot product can be a model drift training data point that can be used as an additional meta training data point along with calculated divergences training data for the meta-ML model 120 for learning a mapping from the space of divergence in input features to the observed metric drift. In this respect, the dot product effectively augments the meta training data with an additional dimension. For example, the model explainability module 150 can generate a model or concept drift meta training data point that includes the computed dot product and add the model drift meta training data point to the meta training data 130.

The preceding example uses the dot product to compare the vector representation of the set of top input features and a vector representation of the set of baseline input features, but this is only one example of a way that these two vector representations can be compared for attributing drift to model or concept drift. Other methods, such as the Euclidean distance, the cosine similarity, can be similarly used. Other approaches, including approaches that do not rely on vector representations, may also be used for attributing drift to model or concept drift.

FIG. 8 shows an example of a drift attribution report 800 as may be generated, by example, by the output module 155 following a determination of drift attribution or contributions to drift from one or more input features by the model explainability module 150 (e.g., using a Shapley explainer). Report 800 is one example of how the output of the meta-ML model 120 or the model explainability module 150 could be visually represented. The example report 800 is based on an ML model 105 that models customer lifetime value, which can predict how much revenue a customer could bring in during a long-term future period of time, but any suitable ML model 105 modeling a particular phenomenon could be used.

Report 800 includes input features 810. The input features 810 can include descriptive labels and other information relevant to interpretability. For example, the input feature labels may include an indication of the value 817 of the input feature in a recent measurement. The report 800 includes the predicted output metric drift 815. The predicted output metric drift 815 is generated by the meta-ML model 120 and is the value to which the drift attributions 820 (e.g., the Shapley values) will sum. In some examples, the predicted output metric drift 815 includes both the value to which the drift attributions 820 will sum as well as the expected output drift(e.g., the expectation value of the output drift given the selected background dataset). In examples where the regularization procedure described with respect to FIG. 7 above has not been applied, the expected output drift 660 may not equal zero, which can reduce or otherwise affect the interpretability of the predicted output metric drift 815.

The drift attributions 820 can be a visual representation of the contribution of each of the input features 810 to the predicted output metric drift 815. In this example representation, blue bars represent negative output metric drift and red bars represent positive output metric drift. The length of each bar is proportional to the magnitude of the estimated contribution to the predicted output metric drift 815. The report 800 may include the magnitude 840 of the drift attribution. The report 800 may also include the expected value of the metric output drift 830, denoted as E[f(x)], as described above with respect to FIG. 6. In this example, the expected value of the metric output drift 830 is close to zero, indicating that baseline values for the output metric drift have been used as the background dataset for the explainer.

In this example, the drift attributions 820 are sorted according to magnitude, but other visualizations may be used. For instance, the largest contribution to the predicted output metric drift 815 of −1.891 is from the feature labeled input “CCX_EVENT_TargetType_TYPE_Target_doclistPurge_COUNT_L30,” which is contributing −1.99 to the predicted output metric drift 815. This example represents the number of times users have purged documents from a particular software application, but the input features can include any categorical or numerical value that may affect the resultant drifts such as clicks, impressions, page visits, and so on.

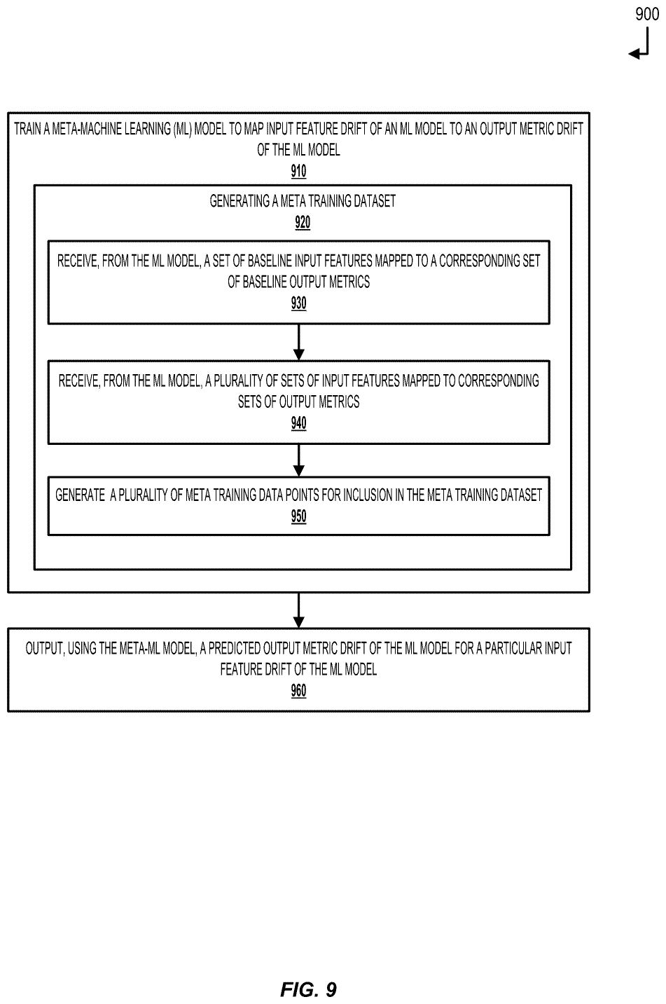

FIG. 9 is a flow diagram of an example process 900 for training a meta-ML model 105 for monitoring and attribution of ML model 120 drift. The process 900 depicted in FIG. 9 may be implemented in software executed by one or more processing units of a processing device, implemented in hardware, or implemented as a combination of software and hardware. This process 900 is intended to be illustrative and non-limiting. The example process herein is described with reference to the drift attribution application 115 depicted in FIG. 1, but other implementations are possible. Although FIG. 9 depicts various processing operations occurring in a particular order, the particular order depicted is not required. In certain alternative embodiments, the processing may be performed in a different order, some operations may be performed in parallel, or operations may be added, removed, or combined together.

At block 910, the drift attribution application 115 trains, using a training module 135, a meta-machine learning (ML) model 120 to map input feature drift 140 of an ML model 105 to an output metric drift 145 of the ML model 105. The ML model 105 is trained to map a set of input features 110 to a set of output metric 117. For example, the ML model may be trained to make predictions about future revenues based on customer engagement and website usage data. The trained ML model 105 may be used in production and monitored by drift monitoring system 107.

The ML model 105 and the meta-ML model 120 may be any suitable type, ensemble of types, or combination of types. In some examples, implementations of the techniques of the present disclosure are agnostic to the type of ML model used. Different types of ML models may be used according to different examples, such as deep convolutional neural networks (“CNNs”); a residual neural network (“Resnet”), or a recurrent neural network, e.g. long short-term memory (“LSTM”) models or gated recurrent units (“GRUs”) models, a three-dimensional CNN (“3DCNN”), a dynamic time warping (“DTW”) technique, a hidden Markov model (“HMM”), a support vector machine (SVM), decision tree, random forest, etc., or combinations of one or more of such techniques—e.g., CNN-HMM or MCNN (Multi-Scale Convolutional Neural Network). Further, some examples may employ adversarial networks, such as generative adversarial networks (“GANs”) or may employ autoencoders (“AEs”) in conjunction with ML models, such as AEGANs or variational AEGANs (“VAEGANs”).

Block 920 includes example steps for generating the meta training data 130. The meta training data 130 may be generated by, for example, the initialization module 125. At block 930, the initialization module 125 receives, from the ML model 105, a set of baseline input features mapped to a corresponding set of baseline output metrics, also known as the “baseline.” Various sets of input features and output metrics can be chosen for the baseline. For example, the baseline might include the set of input features and output metrics recorded shortly following the training of the ML model. Another example may be a set of input features and output metrics that are designated as “ideal” by a developer or user of the ML model 105. For instance, the ideal output metric may be determined using best-case assumptions or aggregate historical data.

Generating the meta training data 130 continues at block 940 by receiving, by the initialization module 125, from the ML model 105, a number of sets of input features mapped to corresponding sets of output metrics. For example, during production operations, sets of input features and corresponding output metrics can be periodically sent to the initialization module 125 for development of the meta training data 130. In some examples, input features and output metrics may be continuously sent to the initialization module 125 to update the meta training data 130 for ongoing or continuous training of the meta-ML model 120.

Generating the meta training data 130 continues at block 950 by generating, by the initialization module 125, a number of meta training data points for inclusion in the meta training data 130. In general, each meta training data point includes an input feature drift value and an output metric drift value. Each meta training data point can be generated by determining, for each set of input features mapped to a corresponding set of output metrics, or snapshot, divergences between the snapshot and the baseline. For example, a divergence between the set of baseline input features and the set of input features, can be computed using a divergence metric such as the directed Wasserstein distance or other suitable divergence metric. Likewise, a divergence between the set of baseline output metrics and the corresponding set of output metrics, can be computed.

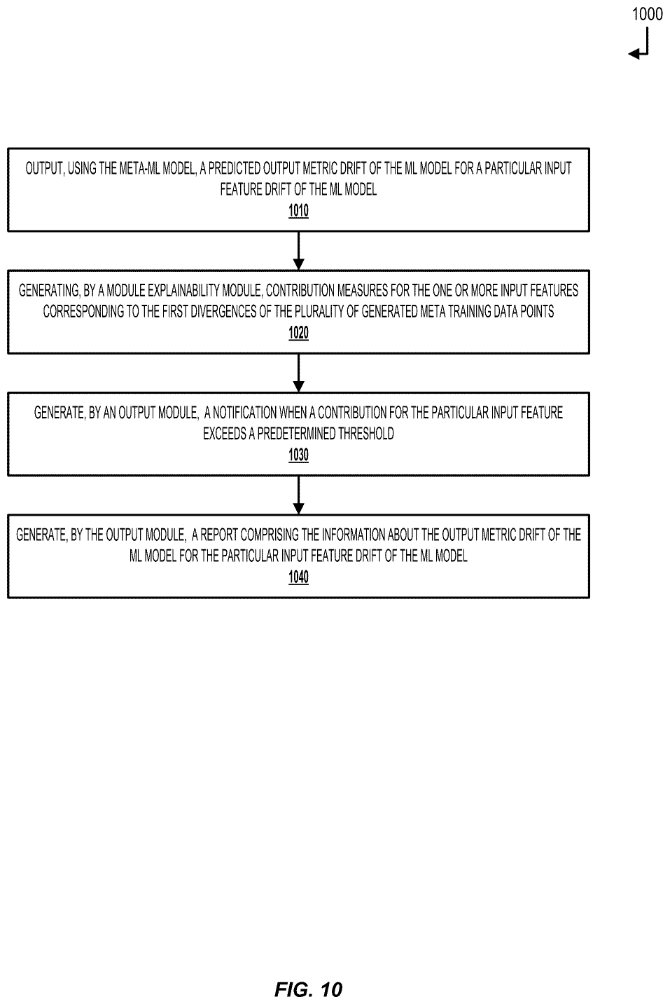

At block 960, the drift attribution application 115 outputs, by the meta-ML model 120, a predicted output metric drift 145 of the ML model 105 for a particular input feature drift 140 of the ML model 105. For example, FIG. 6 depicts an example predicted test output drift 650 for a test input drift 655 that may be generated using a meta-ML model 120 trained using the techniques of process 900. As will be shown in FIG. 10, the output metric drift can be used to determine contributions to the output metric drift from particular input features using an explainability framework such as a Shapley additive explainer.

FIG. 10 is a flow diagram of an example process 1000 for determining contributions to the drift attribution output by a meta-ML model 105 for monitoring and attribution of ML model 120 drift. The process 1000 depicted in FIG. 10 may be implemented in software executed by one or more processing units of a processing device, implemented in hardware, or implemented as a combination of software and hardware. This process 1000 is intended to be illustrative and non-limiting. The example process herein is described with reference to the drift attribution application 115 depicted in FIG. 1, but other implementations are possible. Although FIG. 10 depicts various processing operations occurring in a particular order, the particular order depicted is not required. In certain alternative embodiments, the processing may be performed in a different order, some operations may be performed in parallel, or operations may be added, removed, or combined together.

At block 1010, the drift attribution application 115 outputs, by the meta-ML model 120, a predicted output metric drift 145 of the ML model 105 for a particular input feature drift 140 of the ML model 105. This step may proceed similarly to block 960 of FIG. 9.

At block 1020, the drift attribution application 115 generates, by a model explainability module 150, contribution measures for the one or more input features corresponding to the first divergences of the plurality of generated meta training data points, wherein the contribution measures for the one or more input features are based on the predicted output metric drift 145 of the ML model 105 for the particular input feature drift 140 of the ML model 105. For example, a Shapley explainer trained on top of or using the meta-ML model 120 can be used to generate data for generation of waterfall plots that break down the output metric drift 145 as the weighted sum of input feature drifts 140 that can be intuitive and comprehensible.

The model explainability module 150 may also utilize, instead of or in combination with Shapley explainers, techniques such as feature importance analysis, principal component analysis, partial dependence plots, local interpretable model-agnostic explanations, model agnostic supervised local explanations, global surrogate models, and other explainability methods.

At block 1030, the drift attribution application 115 generates, by the output module 155, a notification when a contribution measure for the particular input feature drift 140 exceeds a predetermined threshold. The notification can include information about the predicted output metric drift 145 of the ML model 105 for the particular input feature drift 140 of the ML model 105.

For example, in an ML model 105 that predicts revenues, the output module 155 could be configured to output a notification if a particular input feature is contributing more than 50% to a measured output metric drift 145. Notifications can likewise be configured to trigger on the drift determinations. For instance, the output module 155 could be configured to output a notification if the predicted revenues increase or decrease by a magnitude of 10% or more. Such notifications can be used individually or in combination.

At block 1040, the drift attribution application 115 generates, by the output module 155, a report comprising the information about the predicted output metric drift 145 of the ML model 105 for the particular input feature drift 140 of the ML model 105. For example, FIG. 8 depicts an example of a graph that could be generated using the output of the model explainability module 150. Other visualizations may be possible such as waterfall charts, Sankey graphs, scatter plots, bar charts, heat maps, tree maps, box plots, histograms, and so on. In some examples, the generated reports or visualizations can be included in a dashboard used by administrators to monitor drift and drift attribution.

### Computing Environment

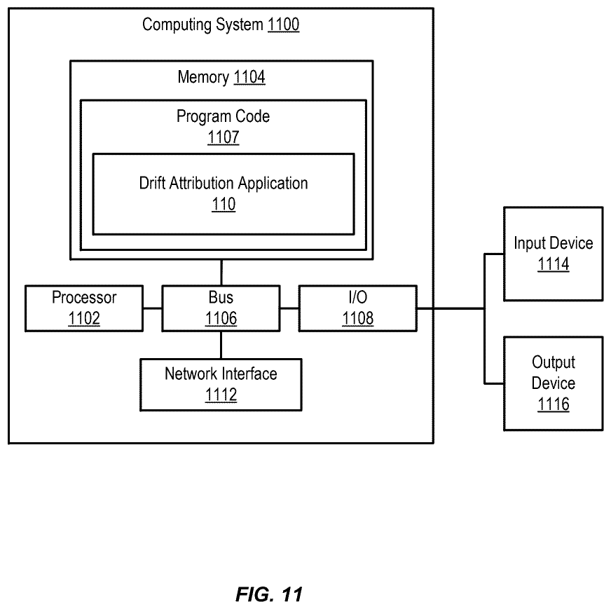

Any suitable computer system or group of computer systems can be used for performing the operations described herein. For example, FIG. 11 depicts an example of a computer system 1100. The depicted example of the computer system 1100 includes a processor 1102 communicatively coupled to one or more memory devices 1104. The processor 1102 executes computer-executable program code stored in a memory device 1104, accesses information stored in the memory device 1104, or both. Examples of the processor 1102 include a microprocessor, an application-specific integrated circuit (“ASIC”), a field-programmable gate array (“FPGA”), or any other suitable processing device. The processor 1102 can include any number of processing devices, including a single processing device.

The memory device 1104 includes any suitable non-transitory computer-readable medium for storing program code 1107, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript. In various examples, the memory device 1104 can be volatile memory, non-volatile memory, or a combination thereof.

The computer system 1100 executes program code 1107 that configures the processor 1102 to perform one or more of the operations described herein. Examples of the program code 1107 include, in various embodiments, the drift attribution application 115 including the several modules described in FIG. 1, which may include any other suitable systems or subsystems that perform one or more operations described herein (e.g., one or more ML models, storage systems, controllers, or function-specific modules). The program code 1107 may be resident in the memory device 1104 or any suitable computer-readable medium and may be executed by the processor 1102 or any other suitable processor.

The processor 1102 is an integrated circuit device that can execute the program code 1107. The program code 1107 can be for executing an operating system, an application system or subsystem, or both. When executed by the processor 1102, the instructions cause the processor 1102 to perform operations of the program code 1107. When being executed by the processor 1102, the instructions are stored in a system memory, possibly along with data being operated on by the instructions. The system memory can be a volatile memory storage type, such as a Random Access Memory (RAM) type. The system memory is sometimes referred to as Dynamic RAM (DRAM) though need not be implemented using a DRAM-based technology. Additionally, the system memory can be implemented using non-volatile memory types, such as flash memory.

In some embodiments, one or more memory devices 1104 store the program code 1107 that includes one or more datasets described herein. In some embodiments, one or more of data sets are stored in the same memory device (e.g., one of the memory devices 1104). In additional or alternative embodiments, one or more of the programs, data sets, models, and functions described herein are stored in different memory devices 1104 accessible via a data network. One or more buses 1110 are also included in the computer system 1100. The buses 1110 communicatively couple one or more components of a respective one of the computer system 1100.

In some embodiments, the computer system 1100 also includes a network interface device 1112. The network interface device 1112 includes any device or group of devices suitable for establishing a wired or wireless data connection to one or more data networks. Non-limiting examples of the network interface device 1112 include an Ethernet network adapter, a modem, and/or the like. The computer system 1100 is able to communicate with one or more other computing devices via a data network using the network interface device 1112.

The computer system 1100 may also include a number of external or internal devices, an input device 1114, an output device 1116, or other input or output devices. For example, the computer system 1100 is shown with one or more input/output (“I/O”) interfaces 1108. An I/O interface 1108 can receive input from input devices or provide output to output devices. An input device 1114 can include any device or group of devices suitable for receiving visual, auditory, or other suitable input that controls or affects the operations of the processor 1102. Non-limiting examples of the input device 1114 include a touchscreen, a mouse, a keyboard, a microphone, a separate mobile computing device, etc. An output device 1116 can include any device or group of devices suitable for providing visual, auditory, or other suitable sensory output. Non-limiting examples of the output device 1116 include a touchscreen, a monitor, a speaker, a separate mobile computing device, etc.

Although FIG. 11 depicts the input device 1114 and the output device 1116 as being local to the computer system 1100, other implementations are possible. For instance, in some embodiments, one or more of the input device 1114 and the output device 1116 can include a remote client-computing device that communicates with computing system 1100 via the network interface device 1112 using one or more data networks described herein.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computer systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

### General Considerations

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included within the scope of claimed embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computer system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as an open and inclusive language that does not foreclose devices adapted to or configured to perform additional tasks or steps. Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Additionally, the use of “based on” is meant to be open and inclusive, in that, a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. A method, comprising:
training, by a training module, a meta-machine learning model (meta-ML model) to map an input feature drift of a machine learning model (ML model) to an output metric drift of the ML model, wherein the ML model is trained to map a set of input features to a set of output metrics, and wherein the meta-ML model is trained using meta training data generated by:
receiving, by an initialization module from the ML model, a set of baseline input features mapped to a corresponding set of baseline output metrics;
receiving, by the initialization module from the ML model, a plurality of sets of input features mapped to corresponding sets of output metrics; and
generating, by the initialization module, a plurality of meta training data points for inclusion in the meta training data, wherein each meta training data point comprises an input feature drift value and an output metric drift value, and wherein each meta training data point is generated by determining, for each set of input features mapped to a corresponding set of output metrics:
(a) a first divergence between the set of baseline input features and the set of input features, the first divergence corresponding to the input feature drift value of the meta training data point; and
(b) a second divergence between the set of baseline output metrics and the corresponding set of output metrics, the second divergence corresponding to the output metric drift value of the meta training data point; and
outputting a predicted output metric drift of the ML model for a particular input feature drift of the ML model.

2. The method of claim 1, wherein:
the first divergence comprises one or more first divergence scores, each first divergence score relating a first input feature value to a second input feature value; and
the second divergence comprises one or more second divergence scores, each second divergence score relating a first output metric value, corresponding to the first input feature value, to a second output metric value, corresponding to the second input feature value.

3. The method of claim 1, wherein generating, by the initialization module, the plurality of meta training data points for inclusion in the meta training data comprises for each set of input features mapped to a corresponding set of output metrics:
determining at least 2 portions of the set of input features based on the corresponding set of output metrics;
determining a weight value for each of the at least 2 portions of the set of input features, wherein the weight value is based on a measure of a size of each respective portion of the set of input features;
computing the first divergence and the corresponding second divergence for each of the at least 2 portions of the set of input feature; and
generating at least 2 curated meta training data points, comprising the first divergences and the corresponding second divergences and the weight values.

4. The method of claim 3, wherein the at least 2 portions of each set of input features are determined based on an equal-width partition of an output metric range of at least one output metric of the corresponding set of output metrics.

5. The method of claim 1, wherein:
the first divergence is determined using a first Wasserstein distance calculation; and
the second divergence is determined using a second Wasserstein distance calculation.

6. The method of claim 5, wherein:
the first divergence comprises a plurality of divergence scores relating a first plurality of input feature values to a second plurality of respective input feature values; and
the sign of the first Wasserstein distance calculation is determined based on a median of a distribution of the plurality of divergence scores.

7. The method of claim 1, wherein generating, by the initialization module, the plurality of meta training data points for inclusion in the meta training data comprises:
determining a range for the plurality of generated meta training data points, wherein the range is bounded by a minimum first divergence and a maximum first divergence;
determining one or more portions of the range; and
designating a portion of the range for each generated meta training data point of a subset of the plurality of generated meta training data points.

8. The method of claim 7, wherein determining the one or more portions of the range comprises dividing the range into a set of equal portions, wherein bounds of each equal portion are defined by the minimum first divergence, the maximum first divergence, and a number of portions.

9. The method of claim 7, wherein determining the one or more portions of the range comprises:
determining a distribution of the first divergences of the plurality of generated meta training data points;
determining one or more cutoff values for the range based on the distribution, the one or more cutoff values defining one or more first portions of the range and at least one remaining portion; and
dividing the at least one remaining portion of the range into a set of equal portions, wherein bounds of each equal portion are defined by the minimum first divergence of the at least one remaining portion, the maximum first divergence of the at least one remaining portion, and a number of portions.

10. The method of claim 9, wherein the range further includes a boundary portion defined by a minimum or maximum value of the first divergence.

11. The method of claim 1, further comprising generating, by a model explainability module, contribution measures for the one or more input features corresponding to the first divergences of the plurality of generated meta training data points, wherein the contribution measures for the one or more input features are based on the predicted output metric drift of the ML model for the particular input feature drift of the ML model.

12. The method of claim 11, wherein generating, using the model explainability module, the contribution measures for the one or more input features are based on a predetermined set of input features corresponding to a predetermined set of input feature drift variables.

13. The method of claim 12, wherein the meta-ML model is trained using a weighted loss function, wherein the weighted loss function is configured to reduce the predicted output metric drift for the predetermined set of input feature drift variables to 0.

14. The method of claim 11, wherein the model explainability module uses Shapley additive explanations.

15. The method of claim 11, further comprising:
determining a set of top input features based on the contribution measures for the one or more input features;
determining a predetermined set of baseline input features corresponding to a predetermined set of input feature drift variables;
using a first vector representation of the set of top input features and a second vector representation of the set of baseline input features, computing a dot product of the first vector representation of the set of top input features and the second vector representation of the set of baseline input features;
generating a model drift training data point comprising the dot product; and
adding the model drift training data point to the meta training data.

16. The method of claim 11, further comprising:
generating, by an output module, a notification when a first contribution measure for the particular input feature drift exceeds a predetermined threshold, the notification comprising information about the predicted output metric drift of the ML model for the particular input feature drift of the ML model; and
generating a report comprising the information about the output metric drift of the ML model for the particular input feature drift of the ML model.

17. A system comprising:
a training module configured to train a meta-machine learning model (meta-ML model) to map an input feature drift of a machine learning model (ML model) to an output metric drift of the ML model, wherein the ML model is trained to map a set of input features to a set of output metrics, and wherein the meta-ML model is trained using meta training data;
an initialization module configured to generate the meta training data, by performing operations comprising:
receiving, from the ML model, a set of baseline input features mapped to a corresponding set of baseline output metrics;
receiving, from the ML model, a plurality of sets of input features mapped to corresponding sets of output metrics; and
generating a plurality of meta training data points for inclusion in the meta training data, wherein each meta training data point comprises an input feature drift value and an output metric drift value, and wherein each meta training data point is generated by determining, for each set of input features mapped to a corresponding set of output metrics:
(a) a first divergence between the set of baseline input features and the set of input features, the first divergence corresponding to the input feature drift value of the meta training data point; and
(b) a second divergence between the set of baseline output metrics and the corresponding set of output metrics, the second divergence corresponding to the output metric drift value of the meta training data point; and
the meta-ML model configured to output a predicted output metric drift of the ML model for a particular input feature drift of the ML model.

18. The system of claim 17, further comprising:
a model explainability module configured to generate contribution measures for the one or more input features corresponding to the first divergences of the plurality of generated meta training data points, wherein the contribution measures for the one or more input features are based on the predicted output metric drift of the ML model for the particular input feature drift of the ML model; and
an output module configured to output the contribution measures.

19. A non-transitory computer-readable medium storing instructions that, when executed by one or more processors, cause the one or more processors to perform operations comprising:
training, by a training module, a meta-machine learning (meta-ML model) model to map an input feature drift of a machine-learning model (ML model) to an output metric drift of the ML model, wherein the ML model is trained to map a set of input features to a set of output metrics, and wherein the meta-ML model is trained using meta training data generated by:
receiving, by an initialization module from the ML model, a set of baseline input features mapped to a corresponding set of baseline output metrics;
receiving, by the initialization module from the ML model, a plurality of sets of input features mapped to corresponding sets of output metrics; and
generating, by the initialization module, a plurality of meta training data points for inclusion in the meta training data, wherein each meta training data point comprises an input feature drift value and an output metric drift value, and wherein each meta training data point is generated by determining, for each set of input features mapped to a corresponding set of output metrics:
(a) a first divergence between the set of baseline input features and the set of input features, the first divergence corresponding to the input feature drift value of the meta training data point; and
(b) a second divergence between the set of baseline output metrics and the corresponding set of output metrics, the second divergence corresponding to the output metric drift value of the meta training data point; and
outputting, by the meta-ML model, a predicted output metric drift of the ML model for a particular input feature drift of the ML model.

20. The non-transitory computer-readable of claim 19, further comprising instructions for:
generating, by a model explainability module, contribution measures for the one or more input features corresponding to the first divergences of the plurality of generated meta training data points, wherein the contribution measures for the one or more input features are based on the predicted output metric drift of the ML model for the particular input feature drift of the ML model; and
outputting, by an output module using the meta-ML model, the contribution measures.
